(19) United States
(12) Patent Application Publication
(10) Pub. No.: US 2008/0152830 A1
(43) Pub. Date: Jun. 26, 2008

(54) Optical Recording Medium Comprising Molecules With Hydrogen Bonds

(75) Inventor: Johannes Theorodus Adriaan Wilderbeek, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,972

(22) PCT Filed: Feb. 17, 2005
(86) PCT No.: PCT/IB2005/050444

§ 371 Date: Aug. 15, 2006

(30) Foreign Application Priority Data
Feb. 17, 2004 (EP) 04100626.3

(51) Int. Cl. C08F 2/46; B05D 5/06

(52) U.S. Cl. 427/508; 427/162

(57) ABSTRACT

The invention relates to an optical recording medium comprising at least one liquid crystalline (LC) layer including an anisotropic aligned LC polymer network, low molecular weight molecules, at least part of it being LC and orientable and at least part of it having functional groups for effecting hydrogen bonding with each other, and optionally a dye, and to a method for manufacturing said optical recording medium comprising the steps: a. applying onto a substrate at least one LC layer comprising LC monomers, low molecular weight molecules at least part being LC and orientable and at least part having functional groups for effecting hydrogen bonding with each other, and optionally a dye; b. heating the mixture to above a phase transition temperature; c) orienting the LC monomers into one direction; and d) converting the oriented LC monomers to a polymeric network. Further a method for writing information in an area of the optical recording medium has been claimed wherein at least one area in at least one of the LC layers is heated to above a phase transition temperature, and provided with optically readable information by: a. orienting in said area the LC molecules and optionally the dye to a direction that is different from the direction of the orientation of the polymeric network; b. cooling said area of the LC layer to below said phase transition temperature to freeze the direction of the oriented LC molecules and optionally the dye; and optionally repeating steps a. and b.

The invention relates to an optical recording medium, a method for manufacturing said optical recording medium, and a method for writing information in said medium.

The present invention is in the field of optical recording media, such as compact discs (CDs) and digital tapes or cards, so-called WORM media (write-once-read-many-times compact discs or tapes) and rewritable CDs and tapes. These types of media allow information to be written by the consumer.

In conventional read-only CDs the information is stored in pits, which are embossed in the disc. The reading is based on diffraction on the regular pit-edge structure. Interference of the diffracted orders is dependent on the position of the laser spot. This results in a modulation in reflection, which is used for reading the information. The conventional read-only CDs are only suitable for large-scale production as the production steps (for obtaining a written disc) are rather complicated and therefore only cost effective in mass production. Hence there is need for CDs and digital tapes or cards, which can be produced in smaller quantities or can even be written by the consumer himself. For instance, the optical recording medium comprises a light transmitting substrate having a deformable surface, a light absorptive layer overlaying the deformable surface, and a light reflective layer overlaying the light absorptive layer, said deformable surface being deformable by energy generated upon absorption of the writing laser beam by the light absorptive layer, to form optically readable pits. The reading is again based on interference of diffracted orders. During irradiation with the reading laser the light travels through the light absorptive layer and is reflected by the reflective layer. As the refractive index within a pit differs from the refractive index outside it (land), the optical path length within the pit differs from that of the land. The laser light that falls within the pit interferes with the light that falls on the land causing diffraction. The interference of the diffracted orders depends on the exact position of the reading spot. The resulting reflection modulation is used for reading the information.

It is also known in the field of optical storage of data to use liquid crystal molecules having a glass transition temperature Tg. For instance, document U.S. Pat. No. 5,976,638 concerns an optical recording medium comprising a homotropically oriented liquid crystalline polymer film containing liquid crystal molecules having a glass transition temperature Tg, and dichroic dye molecules, both being oriented perpendicular to the surface of the film.

In general, the absorption dipole moment of a dichroic dye coincides with the long axis of the chromophore and therefore, the absorption of dichroic dye molecules is clearly directional. In a non-written film the liquid crystal molecules and hence the dichroic dye molecules are homeotropically oriented and show only low absorption of the incident light. By local heating or by irradiating (e.g. by a laser) to a temperature above the glass transition temperature Tg of the liquid crystal molecules said homeotropically orientation is converted into an isotropic one. As the irradiated or heated areas are cooled off rapidly (below the Tg of the liquid crystal crystalline polymer), the isotropic orientation is frozen in. As the dichroic dye will likewise be isotropically oriented, this results in a substantially higher absorption of the incident light.

A disadvantage of this method is the long relaxation time of the LC molecules, during which entire length the trace (or data pit) that is written has to be kept at a temperature above the glass transition temperature (Tg), when used for information storage.

A further disadvantage is the need to rapidly cool off the written area to a temperature below the glass transition temperature in order to freeze in the isotropically oriented dichroic dye molecules.

In the field of liquid crystal displays it is known to use a dilute anisotropic liquid crystal polymer network. The anisotropic LC polymer network itself is then typically made of cross-linked liquid crystal molecules in the presence of an abundant second type of liquid crystal molecules, both types being aligned in a direction determined for instance by an alignment layer. The network exerts a force on the second type of LC molecules, anchoring them to the network. Still, by applying an electric field it is possible to orient the second type of LC molecules in a second direction. However, upon switching off external field, the network force drives the second type of molecules back to their initial orientation, making their second orientation unstable.

It is an object of the present invention to provide an optical recording medium, which combines stability of written and unwritten data with high writing speed and good sensitivity during writing.

In an attempt to apply the hereinabove-described method for LC displays to the field of optical storage of information it was found that the state of orientation of the LC molecules oriented by the applied external field, i.e. the second orientation, is unstable, requiring said external field being switched on in order to prevent said LC molecules from relaxing and reorienting. However, it was also found that this method can be utilized for information storage by equipping each storage layer with electrodes and by locally destroying said electrodes upon writing information. Therefore, LC molecules in non-written data pits only, will be affected by the applied electric field and forced to change their orientation when addressed upon reading. A drawback of such method is the usage of electrodes, which makes is implementation complex and expensive.

These and other problems and disadvantages were solved according to the optical recording medium of the present invention.

To this end the invention relates to an optical recording medium comprising at least one liquid crystalline (LC) layer including an anisotropic aligned LC polymer network, low molecular weight molecules, at least part of it being LC and orientable and at least part of it having functional groups for effecting hydrogen bonding with each other, and optionally a dye.

Said layer has the form of a glassy matrix, ideally having a low initial mobility (which inversely is proportional to the viscosity, hence has a high viscosity) at ambient temperature, whereas a high mobility is obtained (low viscosity) at high temperatures to facilitate the reorientation of the liquid crystalline director. In between these two extremes, a steep, reversible temperature threshold is present. The threshold introduces non-linearity for writing, which is especially relevant to multilayer data storage concepts, as the threshold condition is only fulfilled in the in-focus layer, whereas the out-of-focus layers will have a temperature profile still below the threshold. A steep threshold is preferred to minimize the required temperature difference between individual information bits and between adjacent layers.

In the present invention, a combination is used of liquid crystalline materials exhibiting non-covalent interactions based on multiple hydrogen bonds. These materials display interactions with strength in between that of covalent bonds (200-400 kJ mole⁻¹) and that of the weak van der Waals forces (about 1 kJ mole⁻¹). Hydrogen bonds are generally formed between functional groups comprising oxygen, nitrogen, or fluorine, bearing a hydrogen atom, and such atoms in the same or a different molecule. The strength of the interaction is concentration and temperature dependent. Generally, the interaction is weakened with increasing temperature. The concentration of molecules is not only determined by the shear number within a certain volume, but also by the amount of possible hydrogen bonds per molecule. This has for instance led to the design of special architectures based on hydrogen bonding abilities, that have been evaluated for electro-optical characteristics: Other architectures that exist even up to high temperatures are based on triple quadruple hydrogen bonds with special arrangements in the donor and acceptor groups. Apart from the broad temperature range, another important feature of these molecules is their strong temperature dependence of the viscosity and the large change in magnitude that is covered This dependence is stronger than commonly observed in conventional, covalently-linked materials: which has important consequences for the presence and steepness of a temperature threshold. Whereas the viscosity of the system can generally be lowered through the addition of low molecular weight (liquid crystalline) molecules to the matrix, resulting in a drastic lowering or even disappearance of the required temperature threshold, the presence of hydrogen bond-based materials will preserve or re-instate this temperature threshold, due to its steep intrinsic viscosity—temperature dependence. The presence of this temperature threshold is of utmost importance for the concept of this invention, both for single layer storage and multilayer storage, as it introduces a non-linear effect for writing and minimizes the required temperature difference between individual information bits, both lateral and between adjacent layers. The position of the threshold, the absolute values of the viscosity and steepness of the viscosity—temperature dependence can be further tailored by appropriate adjusting the composition and/or structure of the matrix, e.g. hydrogen bond-based material. The low molecular weight molecules having functional groups for effecting hydrogen bonding are not necessarily LC molecules. If only low molecular weight molecules having functional groups for effecting hydrogen bonding are used, at least part should be LC and orientable and have a specific phase transfer (first or second order, or glass transition).

Consequently, a desired system will constitute:

a. a low molecular weight liquid crystalline material or mixture forming a continuous phase, serving as the mobile fraction, and which may preferably, but not necessarily, comprise a liquid crystalline material or mixture with a glass transition or a first or second order temperature-induced phase transition, such as a melt transition, serving as the temperature threshold below which a low mobility of the overall system is present, and above which a high mobility of the overall system is present. The mobility of the overall system will be largely determined by that of the continuous phase;
b. preferably, a small fraction of a dissolved anisotropic (preferably fluorescent) dye or mixture of dyes, needed for the contrast generation (planar vs. homeotropic state) that is used for data storage;
c. an aligned liquid crystalline network, acting as the driving force for the temperature-induced or orientation of the mobile phase;
d. a hydrogen bond-based material or mixture, that (i) will lower the viscosity of the system at elevated temperature (e.g. 200° C.), (ii) will preserve or re-instate the temperature threshold of the liquid crystalline material or mixture with e.g. a first or second or order temperature-induced transition, due to its intrinsic steep viscosity-temperature dependence, (iii) will effect a high viscosity at ambient temperature, resulting from its intrinsic steep viscosity-temperature dependence; and
e. optionally, isotropic or mesogenic additives such as thermal initiators, photo initiators, inhibitors, radical scavengers, chain transfer agents, stabilizers, plasticizers, surfactants, sensitizers, dopants, or combinations thereof.

In a preferred embodiment the low molecular weight molecules are a mixture of molecules part of having and part of not having functional groups for effecting hydrogen bonding with each other. At least one of the molecules should have the ability to adopt a meta-stable state for storage of information. Upon writing information the molecules of these bits return to their original orientation, for instance by heating. If not used in a mixture of other LC and orientable molecules, at least part, preferably all, of the low molecular weight molecules with functional groups for hydrogen bonding is LC and orientable.

Examples of molecules not having functional groups for effecting hydrogen bonding are low molecular weight, rod-shaped (calamitic), or disc shaped (discotic) liquid crystals that show vitrification. Examples are mesogenic compounds with condensed ring systems at the center of the molecules such as the compound shown in Figure Va, or mesogenic compounds with azobenzene functionalities such as the compound shown in Figure Vb, or so-called Siamese-twin molecules as shown in Figure Vc. Other examples can for instance be found in literature (e.g. Wedler, W., Demus, D., Zaschke, H., Mohr, K., Schafer, W., and Weissflog, W., J. Mater. Chem., 1 (3), 347-356 (1991)).

Examples of molecules having functional groups for effecting hydrogen bonding are for instance trans-(1R,2R)-bis(dodecanoylamino)cyclohexane (structure a in Figure Vd), or 2-butylureido-6-methylpyrimidone (structure b in Figure Vd).

The optical recording medium comprises a dye, preferably a fluorescent dye. Examples of such dyes are 1,1′-diethyl-2,2′-carbocyanine iodide, 2-[6-(diethylamino)-3-(diethylimino)-3H-xanthen-9-yl]benzoic acid, 2,3,5,6-1H,4H-tetrahydro-9-(3-pyridyl)-quinolizino[9,9a,1-gh]coumarin, 2-(p-dimethylaminostyryl)-pyridylmethyl iodide, 2-(p-di-methylaminostyryl)-benzothiazolylethyl iodide, coumarin 7, coumarin 152, coumarin 314, coumarin 1 hydroperchlorate, and coumarin 153.

The polymers constituting the polymer network are made by polymerizing monomers, such as (multifunctional) liquid crystalline acrylates, epoxides, methacrylates, thiol-enes, as for instance C3M in Figure Ve.

In a preferred embodiment the polymer network comprises 0.1 to 40 wt. %, preferably 5-10 wt. %, and the low molecular weight molecules 60-99.9 wt. %, preferably 85-95 wt. %, of the LC layer.

Further, if the low molecular weight molecules are a mixture of molecules with and without functional groups, the preferred ratio of low molecular weight molecules with and without functional groups is from 1:30 to 30:1, preferably 1:10 to 10:1, more preferably from 1:5 to 5:1.

The medium can have at least one of the LC layers comprising pre-recorded record control information or write-once information. Usually, at least one of the LC layers is provided on a substrate.

The invention further provides a method for manufacturing said optical recording medium comprising the steps:

a. applying onto a substrate at least one LC layer comprising LC monomers, low molecular weight molecules at least part being LC and orientable and at least part having functional groups for effecting hydrogen bonding with each other, and optionally a dye;
b. heating the mixture to above a phase transition temperature;
c. orienting the LC monomers into one direction; and
d. converting the oriented LC monomers to a polymeric network, preferably by actinic irradiation.

The invention also provides a method for writing information in an area of the optical recording medium wherein at least one area in at least one of the LC layers is heated to above a phase transition temperature, and provided with optically readable information by

a. orienting in said area the LC molecules and optionally the dye to a direction that is different from the direction of the orientation of the polymeric network;
b. cooling said area of the LC layer to below said phase transition temperature to freeze the direction of the oriented LC molecules and optionally the dye; and
c. optionally repeating steps a. and b.

Advantages of the invention are the facilitation of actual implementation of an optical storage concept using the network-enforced reorientation of a glassy liquid crystalline matrix, having the additional advantages of increased stability of stored information, fast writing speeds comparable to conventional network-enforced liquid crystal displays, independent possibility of optimization of material properties and additionally, in case of anisotropic fluorescent dyes anisotropic emission of fluorescence having a twofold gain in photons and switching on fluorescence by writing, thereby reducing background signal.

The invention provides optical reading media having a steeper viscosity—temperature dependence than conventional systems and can be used in various applications such as optical (multilayer) data storage, signaling, and safety display function.

The invention can be applied to a single layer, but also to a multilayer optical data storage concept, particularly in a fluorescent multilayer storage system. An additional advantage is that existing and commercially available materials can be used, which can be selected to allow for tailoring the position and steepness of the temperature threshold by adjusting the composition and/or structure of the matrix, e.g. hydrogen bond-based material.

Furthermore, the invention can also be applied to other applications, such as indicator and signaling applications, used for security, safety and precaution purposes. Since the change in contrast of the system originating from the reorientation of the incorporated dye molecules is temperature dependent, a system may for instance be envisaged where an initially transparent, an initially non-absorbing and non-colored system is transformed into an opaque, absorbing and colored system when a certain safety temperature is exceeded. In principle, this transition can be one-way, but can easily be extended to a reversible, bistable system when the system is for instance incorporated between electrodes.

The invention is illustrated below by the following figures and non-limitative embodiments.

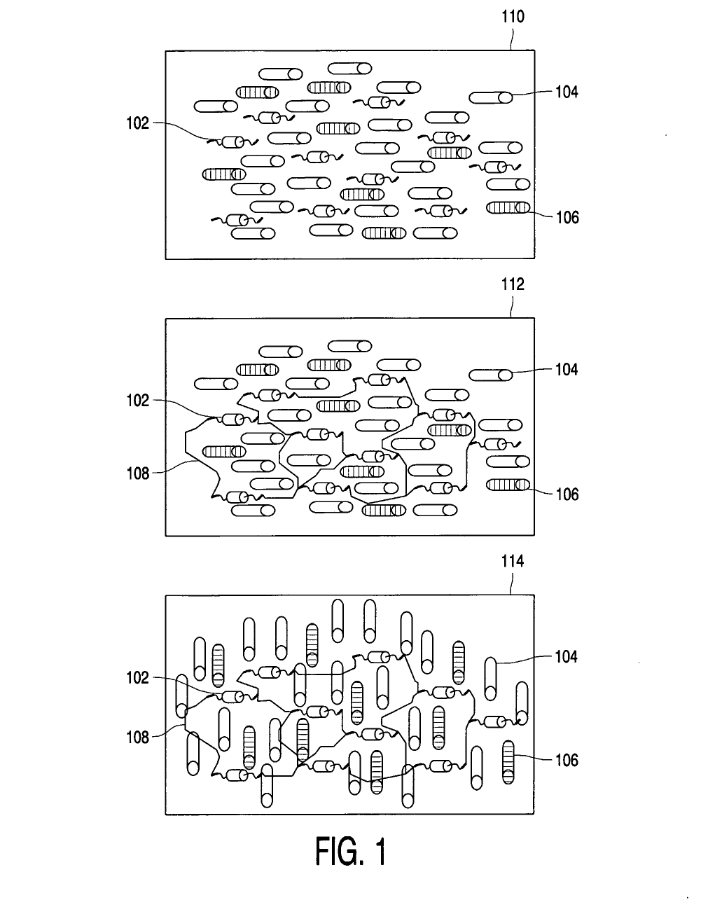

FIG. 1 shows an upper, a middle, and lower panel that schematically illustrate different states that are passed during the formation of an LC layer comprising LC molecules in a meta-stable orientation, tapped in a dilute oriented LC polymer network.

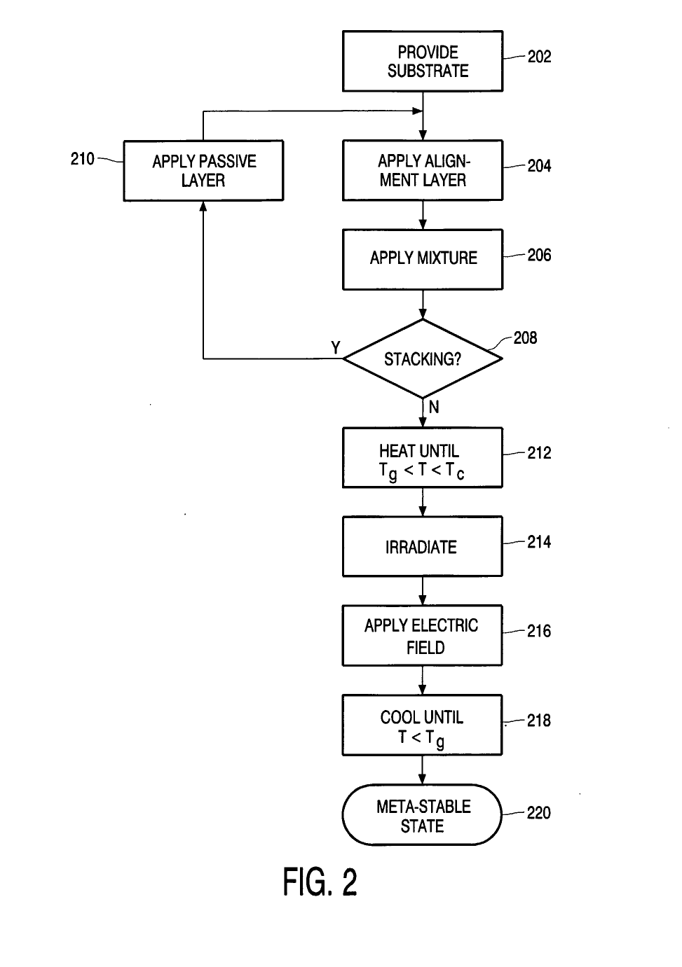

FIG. 2 shows a flow-chart of a preferred embodiment method to manufacture a readable medium for optical storage of information.

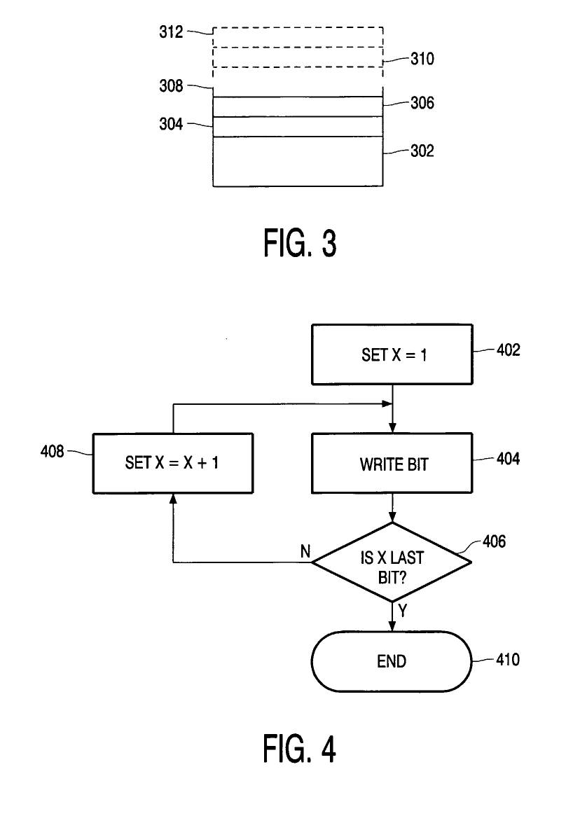

FIG. 3 depicts the construction of a multi-layered optical reading medium for optical storage of information.

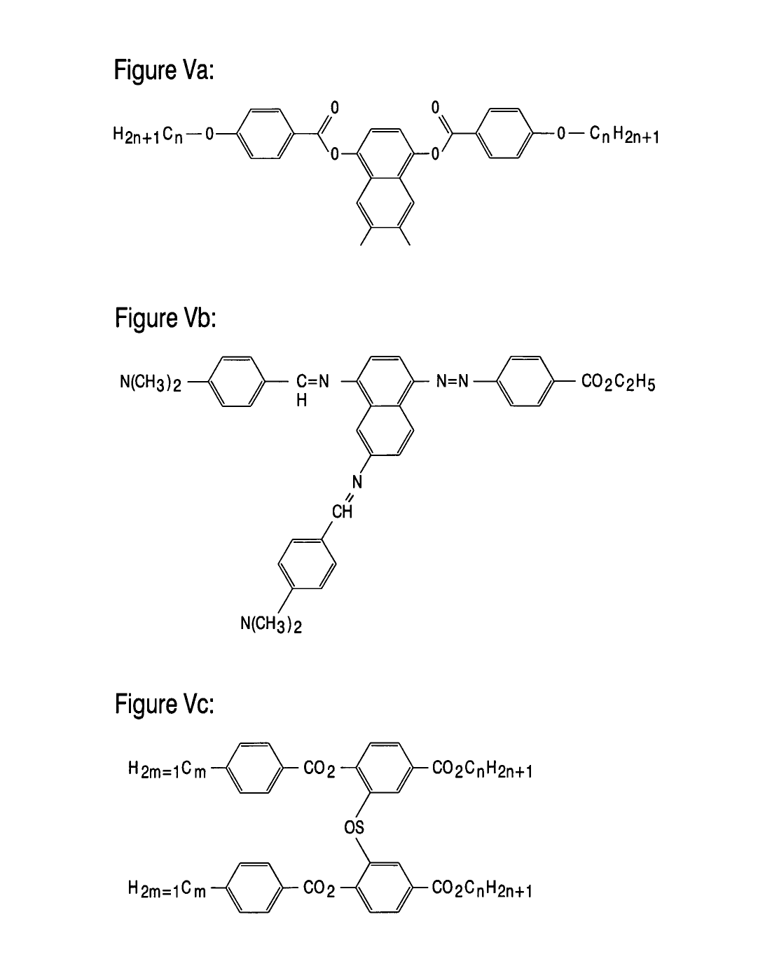

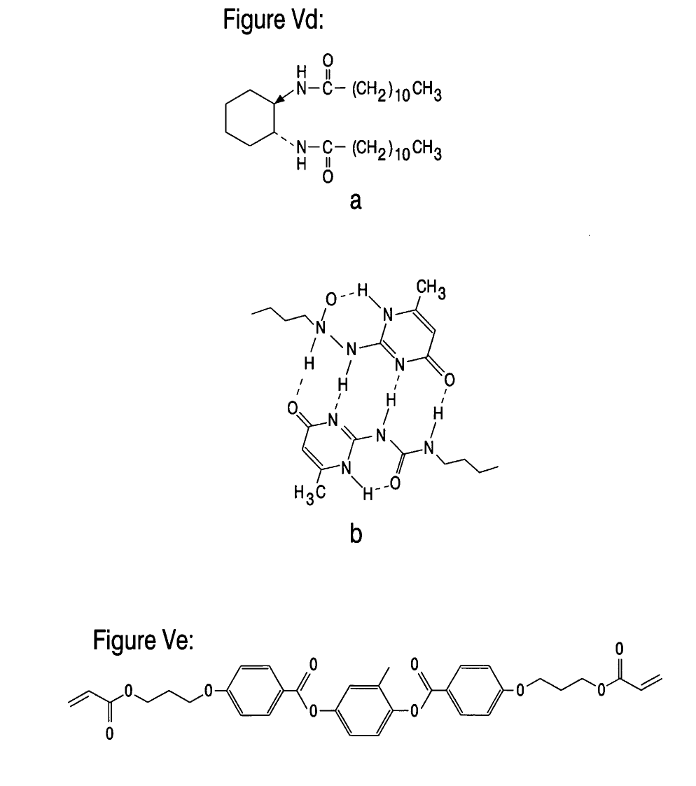

FIG. 4 shows a flow-chart of a method of writing data into an optical reading medium.

Reference will now be given to the upper, middle, and lower panels of FIG. 1 illustrating the different states that are passed during the formation of a dilute liquid crystal layer containing LC molecules in a meta-stable orientation, for providing an optical reading medium according to a preferred embodiment. Such an LC layer can be obtained by first applying a mixture onto a substrate that is pre-coated with an alignment layer. This mixture is prepared by dissolving a few percent of liquid crystalline monomers 102 with the ability to crosslink to each other, i.e. they are reactive, an amount of dichroic fluorescent dye molecules, 106, and a mixture of liquid crystal molecules 104, which contain molecules with a function to form a hydrogen bond and which further may also contain LC molecules not having such function. This state is schematically illustrated in the upper panel of FIG. 1. Upon raising the temperature above the glass transition temperature of the mixture of liquid crystal molecules, and below the clearing temperature of the same mixture, the monomers and the molecules align themselves in a direction defined by the underlying alignment layer.

By polymerizing the LC monomers 102 a polymer network 108 of aligned LC polymer is formed, as shown in the middle panel of FIG. 1. The orientation of said aligned network of LC monomers 102 is maintained in the formed anisotropic polymer network 108 and defines the orientation of the same network.

A strong anchoring of the LC molecule 104 to the anisotropic LC polymer network 108 is thus obtained and the orientation of the LC molecules will thus be determined by the orientation of the LC polymer network 108. Nevertheless, under external fields (e.g. electric fields or magnetic fields) it is still possible to change the overall orientation (deform the director profile) of the LC molecules 104 and the dichroic fluorescent dye molecules 106 to achieve a second overall orientation, different from first orientation of these molecules, which is shown in the lower panel of FIG. 1. The orientation of the anisotropic LC polymer network 108 itself is not changed by the application of this field. Due to the strong anchoring of the LC molecules 104 to the LC polymer network 108 thus obtained, the deformation of the director profile will result in a substantial increase of the deformation energy. Upon switching off the applied external field, the high deformation energy drives the LC molecules 104 to relax to, or close to, their original orientation, coinciding with the orientation of the LC polymer network 108. This relaxation reorientation of abundant molecules forces the dichroic fluorescent dye molecules 106 to change their orientation accordingly. The force exerted by the anisotropic polymer network increases the relaxation rate, as compared to the case where there is no LC polymer network present and anchoring of the LC molecules is performed at an alignment layer only.

However, by using liquid crystal molecules associated with a glass transition temperature Tg as the LC molecules 104 and by decreasing the temperature to a temperature below Tg, prior to switching off said external field, the second orientation of said LC molecules 104 and the dichroic fluorescent dye molecules 106 is frozen in and maintained. Obtained is thus a polymer network 108 aligned in one direction and liquid crystal molecules 104 and fluorescent dye molecules 106 oriented in a second direction, as is schematically shown in the lower panel of FIG. 1. The state of orientation of the LC molecules, thus achieved is a meta-stable state of orientation.

Molecules with the ability to adopt a meta-stable state can be used for storage of data. Upon writing of a data bit, the molecules in a meta-stable orientation of this bit return to their original orientation, whereas the molecules of non-written data bits stay in their meta-stable orientation.

Due to the different orientation of the liquid crystal molecules in the written and non-written bits, these show slightly different refractive index. This difference is however minimized at the production stage of the optical readable medium. Thus an optical reading medium according to a preferred embodiment has been described.

A preferred method of producing an optical storage medium according to the invention will now be described in relation to FIG. 2.

Onto a provided substrate, step 202, an alignment layer is applied at step 204, to align molecules to be applied onto said substrate. A mixture comprising liquid crystal molecules and liquid crystal monomers, of which the monomers have the ability to form a network upon irradiation with for instance ultra-violet (UV) light, and the other has not this ability, is subsequently applied on top of the alignment layer on the substrate in order to form an LC layer at step 206. Said mixture also comprises, preferably fluorescent, dye molecules and photo-initiator molecules (not shown).

In the case more than one LC layer is to be provided, “Y” is chosen at step 208, i.e. when a stack of layers is to be provided, a passive layer is applied at step 210, followed by the previously mentioned steps 204-206. This is repeated until a stack of a desired number of LC layers has been obtained, and hence the alternative “N” at step 208, as an answer to “stacking?” is chosen

Subsequently, the LC layer(s) is/are heated to a temperature (T) that is above the glass transition temperature (Tg) of the liquid crystal mixture applied and below the clearing temperature (Tc) of said mixture at step 212. At this stage at the temperature T of the liquid crystal molecules and monomers, and the fluorescent dye molecules are aligned and oriented in the direction as determined by the alignment layer. While keeping the whole structure or sample at said temperature T, said sample is irradiated by UV-light at step 214, causing the first type of liquid crystal molecules to crosslink with each other, forming a polymer enforced LC layer.

Maintaining the sample at temperature T, an electric field is applied over said sample, e.g. by conveniently using a corona discharge, causing the liquid crystal molecules to change their orientation into a direction substantially perpendicular to the direction of said network at step 216. Subsequently, the sample is cooled to a temperature below said glass transition temperature Tg at step 218. An optical reading medium containing a meta-stable state of orientation in which the liquid crystal molecules are oriented preferably perpendicular to the direction of the anisotropic LC polymer network, is thus obtained at step 220, as is schematically illustrated in the lower panel of FIG. 1.

This thus provided medium is schematically depicted in FIG. 3, showing a side-view of the different layers of the structure, in which the substrate 302 is covered by an alignment layer 304 onto which the polymer enforced glassy LC layer 306 containing the anisotropic LC polymer network, the liquid crystal molecules in a meta-stable state of orientation and the dichroic fluorescent molecules, are provided. If more than one polymer enforced glassy LC layer is to be applied, an inert passive layer 308 is provided onto the glassy LC layer 306, followed by an alignment layer 310 and another glassy LC layer 312, as indicated in FIG. 3 by broken lines. The steps corresponding to the application of these three layers can be repeated until the desired number of layers has been obtained.

Alternatively, the above described heating, illumination steps, application of electric field and cooling can also be performed before the next layer is stacked onto a previous one in a multilayer layout.

The usage of the optical reading medium for optical storage of information will now be explained.

Information is stored by focusing a laser (or by local heating) onto a glassy LC layer, containing the meta-stable state of orientation. In focus, the light beam causes the local temperature at the illuminated point to increase above the glass transition temperature, causing a phase transition for the liquid crystal molecules from the glassy phase to a liquid crystalline or liquid phase with the consequence that the meta-stable state of the liquid crystal molecules vanishes and said liquid crystal molecules relax and adopt an orientation directed according to the LC polymer network. This corresponds to the writing of one bit or a bit-transition. A written bit then, for example, corresponds to a “zero” whereas a non-written bit corresponds to a “one”. The second type of liquid crystal molecules of the written data bits are thus aligned in the direction of the LC polymer network, whereas the non-written data bits are not, but rather oriented in a direction perpendicular to the direction of said network, in the meta-stable state.

Another aspect of the invention is directed towards overcoming the problem of too low a writing speed, making use of the poor heat conductivity of the polymer enforced LC layer, will now be described with reference given to FIG. 4.

The method begins by setting a counter's value X to 1 at step 402. For every data bit that is to be written at step 404, it is determined whether this data bit is a “one” or a “zero.” For either “one” or “zero” heat is applied to an area of the LC layer to be written by a laser pulse or a heating device in order to the addressed area to reach a temperature T above Tg, and thereby writing said data bit. If all data bits that are to be written have been written at step 406, i.e. the counter's value X has reached the final number (last data bit), the method is ended at step 410. If all data bits have not been written (step 406) the counter's value X is set to X+J at step 408, the laser beam is moved to another area, or alternatively the heating device is arranged, to heat another area, whereby steps 404 and 406 will be repeated. For the bits requiring heating, the temperature T to which the addressed data area is heated, is adjusted such that the relaxation of the liquid crystal molecule is substantially accomplished in the time span during which the temperature of the addressed area decreases to the glass transition temperature Tg. Due to the poor heat conductivity of the optical reading medium, a heat pulse with a length in the order of nanoseconds is sufficient to allow a substantially complete switch in orientation (relaxation) within a time span in the order of micro seconds Hence, by using nanosecond-long heat pulses, a high data rate for writing is enabled.

Reading of the written and non-written data bits can be done on the bases of differences in refractive indices, absorption, or fluorescence. In the case of fluorescence, reading is e.g. performed by excitation of dichroic fluorescent molecules, and subsequently detection of the emitted fluorescent light. Fluorescent molecules are excited according to their absorption cross section. Fluorescent molecules oriented in different directions will thus be excited to different extents, leading to differences in the intensity of the emitted light, thus corresponding to different types of information stored (ones and zeros).

As previously indicated the refractive index between molecules in written and non-written bits differ slightly. If more than one glassy LC layers is present in the data storage medium any difference between the refractive index of written and non-written bits will reduce the quality of the beam for the underlying layers and therefore also the performance of the data storage medium. In single layer systems, reading based on the difference in refractive index or absorption between written and non-written bits, is equally suitable compared to fluorescence. In the case with several glassy LC passive and alignment layers alternately stacked onto each other, it is advantageous to minimize this refractive index difference. Fortunately, one embodiment of this invention involving dichroic fluorescent chromophores, enables a careful choice of material in order to minimize said refractive index difference and thus opens up for an optical storage medium having a multi-layered architecture.

Hereinafter some embodiments are exemplified.

### EMBODIMENT I

### Optical Data Storage

A mixture consisting of 1) reactive liquid crystalline monomer or monomers, 2) a reactive or inert material with a first or second order transition well above ambient temperature, optionally with mesogenic properties, 3) an anisotropic dye, preferably a fluorescent dye, 4) a material or mixture of materials possessing one or multiple intramolecular and at least one or multiple intermolecular hydrogen bonds, and optionally 5) one or more additives such as thermal initiators, photo initiators, inhibitors, radical scavengers, chain transfer agents, stabilizers, plasticizers, surfactants, sensitizers or dopants, was deposited on a substrate, such as a disc or a card. The birefringence of the liquid crystalline mixture was chosen such as to minimize scattering effects between the addressed and the non-addressed state. The deposition of the mixture was accomplished using conventional techniques, such as spin coating, doctor blading, (chemical) vapor deposition, sputtering, casting, micro contact printing, and injection molding. The mixture can be applied in its mesophase, but preferably in its isotropic state followed by the fast or slow cooling into the desired mesophase (e.g. nematic, smectic, or chiral nematic phase), allowing for a defect-free liquid crystalline morphology. The mixture was confined between one or two boundary layers, optionally coated with a transparent electrical conductor, such as indium tin oxide or a poly(3,4-ethylenedioxythiophene) derivative. To facilitate the monolithic alignment, alignment-inducing conditions can be used on a single or on both boundary layers, such as mechanically aligned orientation layers, photo induced alignment layers, surfactants, shear or flow-induced forces, and magnetic or electrical fields.

This procedure was repeated for each layer, with the use of an intermediate passive layer to separate the active layers. The refractive index of the intermediate layer was closely matched to that of the active layers, to minimize scattering effects.

The mixture was heated to a temperature above the resulting first or second order transition of the mixture, which can be different from that of the pure compound with a first or second order transition, but below the clearing temperature of the mixture. The mixture was illuminated, preferably with UV-light in the presence of an incorporated photo-initiator, and an aligned anisotropic network was formed.

While maintaining the temperature above the first or second order transition, an electrical field was applied, effecting the reorientation of the mobile liquid crystalline phase and the incorporated anisotropic dye (or a mixture of dyes). Alternatively, magnetic fields or corona discharges can be used to enforce the reorientation.

While maintaining the effective field used for reorientation, the temperature was cooled below the first or second order transition of the mixture and the meta-stable state of the mobile liquid crystalline fraction is frozen-in.

Writing and reading of information was accomplished by the local illumination, e.g. using a laser beam or light emitting diode To distinguish between reading and writing, different intensities were used, with a higher intensity for writing, sufficient to locally heat the material above the first or second order transition

### EMBODIMENT 2

### Display Function

This embodiment is according to Embodiment 1, with the following differences: the design was a single layer design. In an initialization stage, information may be written locally as a means of generating images. In the active state, the induced contrast results from the change of temperature of the environment. Regeneration may be accomplished using the combination of heat and an electrical field. Patterning of the electrodes was optional.

1. An optical recording medium comprising at least one liquid crystalline (LC) layer including an anisotropic aligned LC polymer network, low molecular weight molecules, at least part of it being LC and orientable and at least part of it having functional groups for effecting hydrogen bonding with each other, and optionally a dye.

2. The medium of claim 1 wherein the low molecular weight molecules are a mixture of LC molecules not having functional groups for effecting hydrogen bonding with each other and molecules having functional groups for effecting hydrogen bonding with each other.

3. The medium of claim 1 wherein at least part of the low molecular weight molecules with functional groups is liquid crystalline.

4. The medium of claim 1 wherein the medium comprises a fluorescent dye.

5. The medium of claim 1 wherein the polymer network comprises 0.1 to 40 wt. % and the low molecular weight molecules 60-99.9 wt. % of the LC layer.

6. The medium of claim 2 wherein the polymer network comprises 0.1 to 40 wt. %, preferably 5-10 wt. %, and the low molecular weight molecules 60-99.9 wt. %, preferably 85-95 wt. %, of the LC layer, and the ratio of low molecular weight molecules with and without functional groups is from 1:30 to 30:1.

7. The medium of claim 1 comprising at least two LC layers.

8. The medium of claim 1 wherein at least one of the LC layers comprises pre-recorded record control information or write-once information.

9. The medium of claim 1 wherein at least one of the LC layers is provided on a substrate.

10. A method for manufacturing the optical recording medium of claim 1 comprising the steps:
a. applying onto a substrate at least one LC layer comprising LC monomers, low molecular weight molecules at least part being LC and orientable and at least part having functional groups for effecting hydrogen bonding with each other, and optionally a dye;
b. heating the mixture to above a phase transition temperature;
c. orienting the LC monomers into one direction; and
d. converting the oriented LC monomers to a polymeric network.

11. The method according to claim 10 wherein the oriented LC monomers are converted to a polymeric network by actinic irradiation.

12. A method for writing information in an area of the optical recording medium of claim 1 wherein at least one area in at least one of the LC layers is heated to above a phase transition temperature, and provided with optically readable information by
a. orienting in said area the LC molecules and optionally the dye to a direction that is different from the direction of the orientation of the polymeric network;
b. cooling said area of the LC layer to below said phase transition temperature to freeze the direction of the oriented LC molecules and optionally the dye; and
c. optionally repeating steps a. and b.

13. The method according to claim 12 wherein the LC molecules and optionally the dye are oriented by applying an electric or magnetic field to the LC layer.
